(19) United States
(12) Patent Application Publication
(10) Pub. No.: US 2004/0199396 A1
(43) Pub. Date: Oct. 7, 2004

(54) Methods and systems for creating a behavioral change model

(76) Inventor: Richard D. Carter, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/404,769

(22) Filed: Apr. 1, 2003

(51) Int. Cl. G06F 17/60

(52) U.S. Cl. 705/1

(57) ABSTRACT

A method for creating electronic content is disclosed. The method includes selecting a customer segment, the customer segment representing a target audience for the electronic content. The method further includes selecting a business objective to be accomplished with the customer segment. The method additionally includes selecting a customer need, the customer need pertains to a need by the customer segment. The method further includes developing the electronic content, the electronic content being configured to bridge between the business objective and the customer need. The electronic content includes 1) an awareness component for raising awareness in the customer segment, 2) a motivation component for relating to the need by the customer segment, and 3) a guidance component for guiding the customer segment toward a behavior.

### BACKGROUND OF THE INVENTION

With the widespread use of computers and associated networking technologies as well as with the rising popularity of the Internet as a content distribution medium, digital content, i.e., content created, developed, and/or deployed in a digital format, has become one of the more dominant methods for disseminating information. Over the course of the past few years, for example, websites, web pages, pop-up windows, emails, and the like have become important tools through which content providers can deliver information to content consumers.

Businesses in particular have been enthusiastic in embracing digital content. Many businesses widely employ web sites, web pages, emails, instant messaging, pop-up advertisement windows, and the like to deliver their messages to their audience in hope of influencing the recipient's buying habits and increasing profit. Irrespective whether the electronic content is to be delivered textually, audibly, visually in still images, moving animation, or movie clips, the budget and efforts involved in electronic content creation, development, and deployment have become sizable in many businesses.

Up to now, however, the process of electronic content creation, development, and deployment (CDD) has been fairly ad hoc, spontaneous, and unstructured. Consider the case wherein a computer manufacturer wishes to advertise the benefits of a new feature in a newly introduced computer model. Presently, the process of the electronic content CDD to support this business objective often begins with an explanation by the marketing personnel of the computer manufacturer to the content creators (e.g., web site designers, graphic artists, or art directors) regarding the specific feature(s) to be emphasized. The content creators then come up with a set of conceptual sketches, relying on their formal and/or informal training as well as their experience in creating advertising materials. The various conceptual sketches are then presented to the computer manufacturer for approval.

If one of the proposed conceptual sketches is approved for further development, the content creators would then develop the electronic content in greater detail for further review and approval. Depending on the expertise of the particular content creators involved, multiple review cycles may be required before the electronic content is accepted and is deemed ready for deployment. Some content creators may be more in tune with their clients' business and/or the markets in which their clients operate. For these content creators, fewer review cycles may be required before the message, the format, the deployment methodology, and other aspects of the electronic content are accepted. Other content creators may not be as familiar with their clients' businesses or may be out of synch with their clients, and their work product may require substantially more input and review efforts.

Because of the ad hoc and highly subjective way in which content is currently created, each campaign is essentially a new endeavor that entails starting from scratch. Generally speaking, there is very little leveraging of previously developed content in the creation of new content. This situation is caused in part by the difficulties associated with storing and searching electronic content that may be in different formats (e.g., textual, audible, still images, film clips, moving animation, or a combination thereof). While text storage and text searching technologies have been well developed, searching in movie files or image files or audio files involves technologies that are still, at best, experimental and tend to yield low-value results.

Another problem relates to the lack of commonality and consistency when different contents are created in different campaigns and/or by different content creators. The lack of commonality and consistency is particularly counterproductive in the business arena, where companies frequently seek to reinforce their branding and market position by striving to deliver a consistent and resonant message and/or deliver a consistent/resonant look-and-feel to their customers over time. In many cases, the content developed by a particular content creator may actually conflict with previous messages delivered in the past by the company, and may even be disconnected from the business goal that the business tries to achieve with the campaign.

Once the content associated with a given campaign has been developed, there is always the problem of measuring the success of the campaign. For example, just measuring the number of clicks in a web page yields only a minimal and/or coarse indication of customer interest, especially in view of the fact that there may be multiple possible areas that a visitor may click within that web page. Unless more refined methods of measuring customer interest can be developed, it remains difficult to ascertain whether a particular electronic content is effective and which portion, if any, of the electronic content should be modified or fine tuned to improve effectiveness.

### SUMMARY OF THE INVENTION

The invention relates, in one embodiment, to a method for creating electronic content. The method includes selecting a customer segment, the customer segment representing a target audience for the electronic content. The method further includes selecting a business objective to be accomplished with the customer segment. The method additionally includes selecting a customer need, the customer need pertains to a need by the customer segment. The method further includes developing the electronic content, the electronic content being configured to bridge between the business objective and the customer need. The electronic content includes 1) an awareness component for raising awareness in the customer segment, 2) a motivation component for relating to the need by the customer segment, and 3) a guidance component for guiding the customer segment toward a behavior.

In another embodiment, the invention relates to a method for creating electronic content. The method includes selecting a customer segment, the customer segment representing a target audience for the electronic content. The method further includes selecting a business objective to be accomplished with the customer segment. The method additionally includes selecting a customer need, the customer need pertains to a need by the customer segment. The method also includes developing the electronic content, the electronic content being configured to bridge between the business objective and the customer need. Developing the electronic content includes obtaining an awareness component, a motivation component, and a guidance component. The awareness component is obtained by searching through a content database for the awareness component that satisfies an awareness component criteria inputted into the content database. The motivation component is obtained by searching through the content database for the motivation component that satisfies a motivation component criteria inputted into the content database. The guidance component is obtained by searching through the content database for the guidance component that satisfies a guidance component criteria inputted into the content database.

In yet another embodiment, the invention relates to a method for improving the effectiveness of an electronic content presented to a user via computer-generated outputs. The electronic content has an awareness component for raising awareness in the customer segment, a motivation component for relating to the need by the customer segment, and a guidance component for guiding the customer segment toward a behavior. The method includes a) presenting the awareness component on the computer display screen, b) thereafter, presenting the motivation component on the computer display screen, and c) thereafter, presenting the guidance component on the computer display screen. The method also includes ascertaining, during the steps a), b), and c), whether the user terminates reception of the electronic content. If the user terminates the reception of the electronic content during a given step of steps a), b), and c), the method includes flagging the given step to mark the given step as a step during which the user terminates the reception of the electronic content.

In yet another embodiment, the invention relates to an arrangement for allowing a user to create electronic content. The arrangement includes a content database of previously created electronic content components. The electronic content components include data pertaining to customer segments, awareness components, motivation components, and guidance components. Each of the awareness components is configured for raising awareness in one of the customer segments. Each of the motivation components is configured for relating to a need by the one of the customer segments. Each of the guidance components is configured for guiding the one of the customer segments toward a behavior. The arrangement further includes an interface for allowing the user to specify an awareness component criteria, a motivation component criteria, and a guidance component criteria to obtain a set of electronic content components from the content database. Each electronic content component in the set of electronic content components satisfies at least one of the awareness component criteria, the motivation component criteria, and the guidance component criteria.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates, in accordance with one embodiment of the present invention, an exemplary framework for affecting behavior change in customers.

FIG. 2 conceptually illustrates, in accordance with one embodiment of the present invention, how an electronic content may be stored in a database for later retrieval and usage.

FIGS. 3A and 3B are exemplary flowcharts illustrating the steps for the creation of electronic content and the placement of entries into a content database, in accordance with one embodiment of the present invention.

FIG. 4 is an exemplary user interface for extracting a particular electronic content from a content database in accordance with one embodiment of the present invention.

FIG. 5 is exemplary website implementations of the behavioral change model components in accordance with embodiments of the present invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In one embodiment, the present invention relates to a process for electronic content creation, development, and deployment (CDD) that involves identifying a given set of business objectives and linking those objectives to customer needs. For example, a business objective may be to sell goods/service, to support for sold goods, or to convey information to customers about certain goods/service offerings. It is believed by the inventor herein that in order to be successful, the electronic content should be created, developed, and deployed in a way that not only serves the business objective(s) but also addresses the customer need(s). Stated differently, successful electronic content should bridge the gap between the identified business objective(s) and the customer need(s).

Furthermore there is disclosed, in accordance to another embodiment of the present invention, a behavioral change model having three fundamental components. The behavioral change model represents the framework for electronic content creation, development, and deployment that is well suited for bridging between identified business objective(s) and customer needs.

In one embodiment, the three fundamental components include an awareness component, a motivation component, and a guidance component. Generally speaking, the awareness component relates to how to raise the customer awareness of or how to gain the customer's attention toward certain features of the offered goods/service. The motivation component generally relates to how to motivate the customer by identifying and relating to the customer's needs and desires. Finally, the guidance component generally involves techniques and/or suggestions for guiding the customer toward a desired behavior. It is believed by the inventor herein that an effective electronic content must include all these three components: awareness, motivation, and guidance (AMG). These components may be delivered contemporaneously, at different times, in the same web page or document, or in different web pages or documents as appropriate. However, all three components must be present and sequentially linked across all effective electronic contents.

Moreover, the behavioral change model guides content creators in their thinking and organization while creating and developing the electronic content. The content CDD process becomes more methodical and repeatable, thereby reducing the amount of effort and the overall cost involved in electronic content CDD.

In accordance with one embodiment of the present invention, once the electronic content has been created to bridge the business objective(s) with the customer need(s), the electronic content is then stored and indexed in such as way that future content creators can readily leverage on the work done. Furthermore, there are developed techniques and arrangements for enabling a marketeer to reuse the previously created content without having to start all over. In this manner, there is an increased likelihood that the electronic contents employed in analogous campaigns will share certain common characteristics and will deliver a coherent, consistent message to the customer base.

In accordance with another embodiment of the invention, the behavioral change model provides an effective mechanism for the tracking customer's interest in a given electronic content. By closely tracking a customer's interaction (or lack thereof) relative to the different components of the behavioral change model, it is possible to measure the effectiveness of the electronic content in achieving its business objective(s) and in meeting the customer's needs. In fact, it is possible to ascertain which portion of the electronic content fails to maintain customer interest. This information may be employed to tune the electronic content to increase its effectiveness.

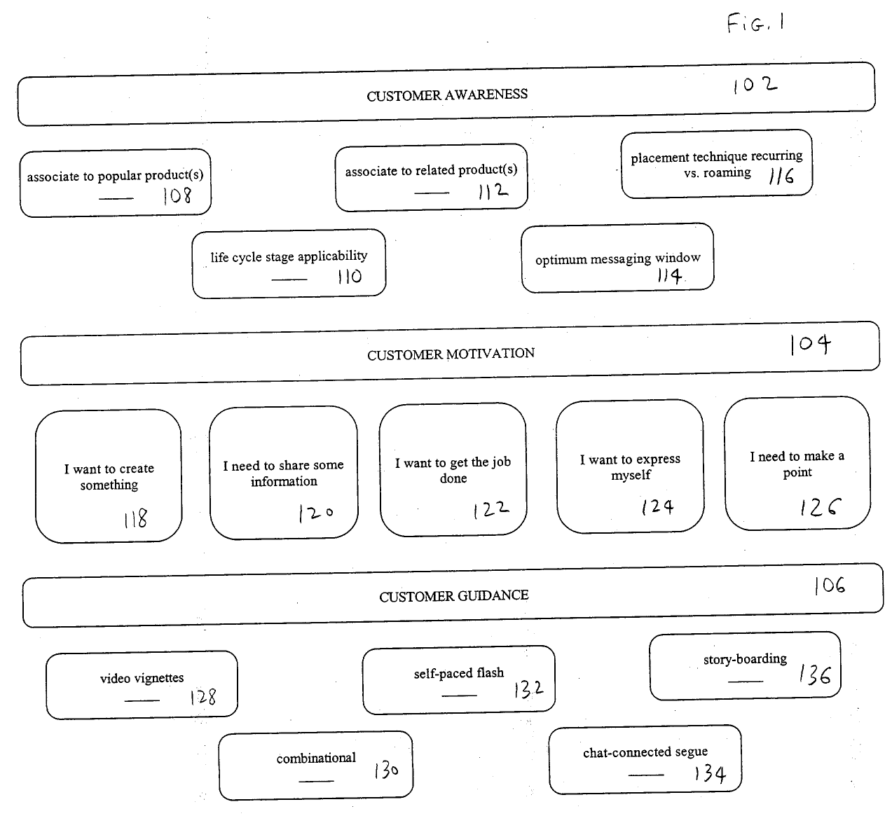

The features and advantages of the present invention may be better understood with reference to the drawings and discussions that follow. In FIG. 1, there is shown an exemplary framework for affecting behavior change in customers. Customer awareness layer 102 relates to capturing the attention of the customer. Customer motivation layer 104 relates to addressing the customer's need, and customer guidance layer 106 relates to guiding the customer into action.

The customer awareness layer 102 of FIG. 1 includes a plurality of exemplary tags for an exemplary campaign. One of these tags in customer awareness layer 102 is the associating to popular product(s) tag 112. If the new product is a printer having a memory stick slot for accepting memory sticks, awareness may be raised if the new product is associated to an existing popular product, such as a popular digital camera that also employs a memory stick.

Life-cycle stage applicability tag 110 represents a tag indicating where in the product lifecycle one should deliver the electronic content. For example, an electronic content may be more effective if delivered within 30 days of purchase, while another electronic content may be more effective if delivered during later stages of the product cycle when the customer is more likely to trade up. Awareness may also be raised by associating the new product to related product(s), as shown by tag 112.

Optimum messaging window tag 114 relates to when may be the best time to reestablish contact with the customer. Placement technique recurring vs. roaming tag 116 relates to how, for example, content can be deployed on a web page. For example, research has shown that the older customers tend to prefer a static web page whereas younger customers tend to prefer dynamic pages with video and frequently updated, moving content. It should be noted that other customer awareness-related tags may exist, and the tags may change depending on the campaign.

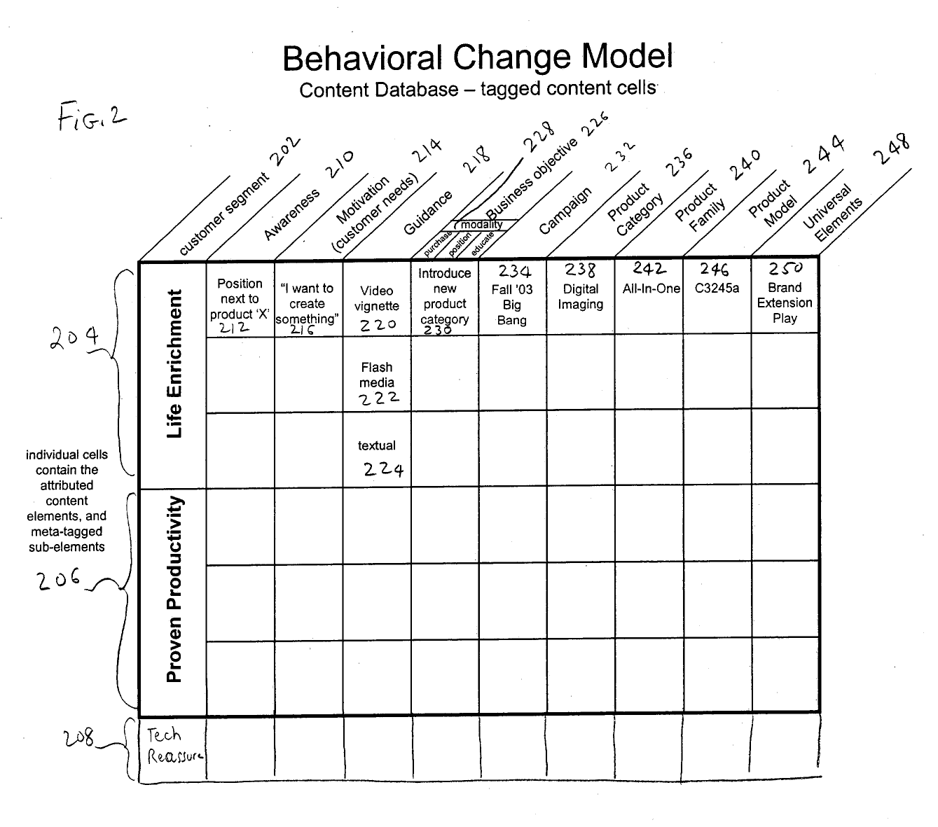

It should be pointed out that techniques for gaining customer awareness may be highly dependent on the customer demographics. A given electronic content may be highly effective at raising awareness with one segment of the customer base but may be ignored by another segment of the customer base. As will be shown in FIG. 2 herein, customer demographics is an important consideration when selecting a content.

Customer motivation layer 114 relates to customer needs and customer motivation. Tag 118 (I want to create something) represents a relevant motivation for some customers. Tag 120 (I need to share some information) is another relevant motivation for other customers. Other tags 122-124 are also shown in FIG. 1, representing other motivations for the customers. As with the customer awareness-related tags, the customer motivation-related tags shown in FIG. 2 are only exemplary and additional/different tags may exist for different campaigns.

Customer guidance layer 106 addresses ways to guide the customer toward a desired behavior. Depending on the customer segment, there may be various ways to effectively guide a customer toward behavioral change. The customer may be guided by, for example, video vignettes (tag 128), a combination of different delivery mechanisms (tag 130), self-paced flash (tag 132), chat-connect segue (tag 134), and story-boarding (tag 136). Again, it should be kept in mind that the customer guidance-related tags shown in FIG. 2 are only exemplary and additional/different tags may exist for different campaigns.

Generally speaking, each content may have multiple tags under any of the three layers, although one tag typically suffices. If there are multiple tags under a particular layer, one tag may be designated as the dominant tag. This is particularly true in the case of the customer motivation layer.

FIG. 2 conceptually illustrates, in accordance with one embodiment of the present invention, how an electronic content may be stored in a database for later retrieval and usage. Even though FIG. 2 is in the form of a table, the rows and columns of FIG. 2 are only illustrative; the various tags and other information pertaining to a particular electronic content may be stored using any suitable database methodology. An electronic content may be indexed by its associated customer segment (202). The current example identifies three different customer segments: a life enrichment segment 204, a proven productivity segment 206, and a technical reassure segment 208. Of course, depending on the make up of the customer base, additional and/or other customer segments may also exist.

In FIG. 2, individual cells in the matrix contain tags associated with the electronic content. These tags are employed, for the purpose of database query, as meta data for the electronic content. That is, they describe different aspects of the electronic content and serve as indices into the electronic content to facilitate searching.

The database is best understood with an exemplary content designed for promoting a color printer. The customer segment is categorized as life enrichment 204. Under awareness column 210, a cell tag 212 indicates that the way to generate customer awareness is to position the color printer next to product “X”. Note that this tag, as well as other tags of FIG. 2, is assigned to the electronic content by the content creator during the content creation and development process. Under motivation column 214, a cell tag 216 indicates that the need to be addressed relates to the customer's desire to be involved in the creation process of a work product (I want to create something).

Guidance 218 includes cell tags video vignette 220, flash media 222, and textual 224. These tags represent ways to deliver the electronic content so that the electronic content will be well received by the targeted demographics and will likely cause the recipient of the electronic content to perform the desired behavior.

Business objective 226 includes different modalities 228, such as purchase, position and educate. Under business objective 226, there is a cell tag 230 (introduce new product category). This cell tag 230 identifies the business objective to be achieved by the electronic content.

In accordance with one embodiment of the present invention, the tags associated with customer segment, customer awareness, customer motivation, customer guidance, and business objective are cross-linked. These tags are most important in categorizing a particular electronic content for storage and subsequent retrieval/usage.

There may be, however, any number of optional tags associated with a given electronic content. Under campaign 232, there is a tag 234 identifying the campaign with which the present electronic content is associated (Fall '03 Big Bang). Under product category 236, there is tag 238 identifying the product category (digital imaging) associated with the electronic content. Under product family 240, there is a tag 242 for identifying the product family (all-in-one) associated with the electronic content. Under product model 244, there is a tag 246 identifying the product model (C3245a) associated with the electronic content. Under Universal elements 248, there is a tag 250 identifying certain universal characteristics of the electronic content. Beyond the tags shown in FIG. 2, there may of course be additional/different tags associated with different campaigns. The tags may also be cross-linked in the data base. Together with the five tags discussed earlier, these tags help to uniquely identify a particular electronic content in the database.

Although FIG. 2 shows only one exemplary electronic content and the tags therefor, a typical database of electronic contents may have hundreds, thousands, or even more electronic contents, each with its own tags. A subsequent user wishing to leverage on the contents stored in the database to achieve a business objective may perform a search through the database using these tag values as search indices. The search may be either for electronic contents whose tags exactly match a set of supplied tags or the result of the search may be ranked according to relevance without requiring exact matches. The result of the search through the database is one or more electronic contents from which the subsequent user can choose to deliver his or her message.

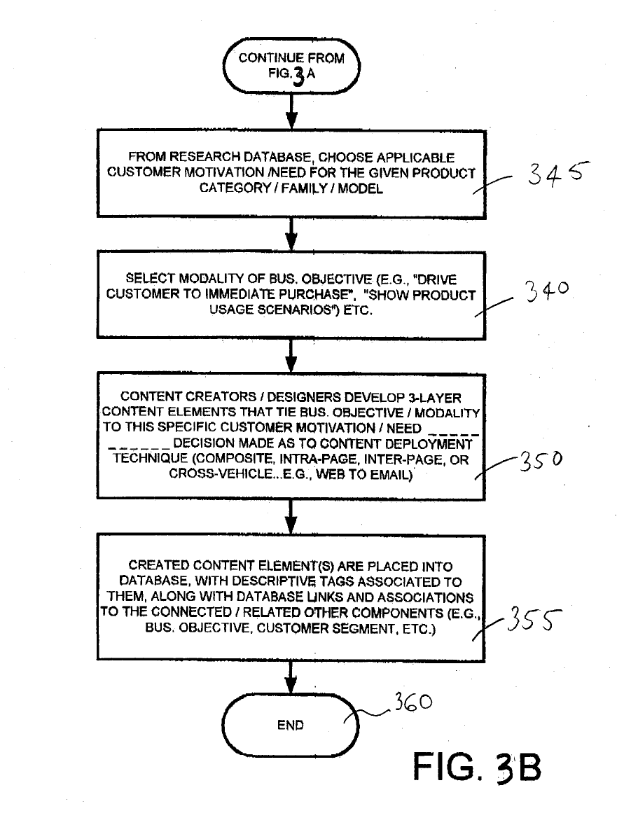

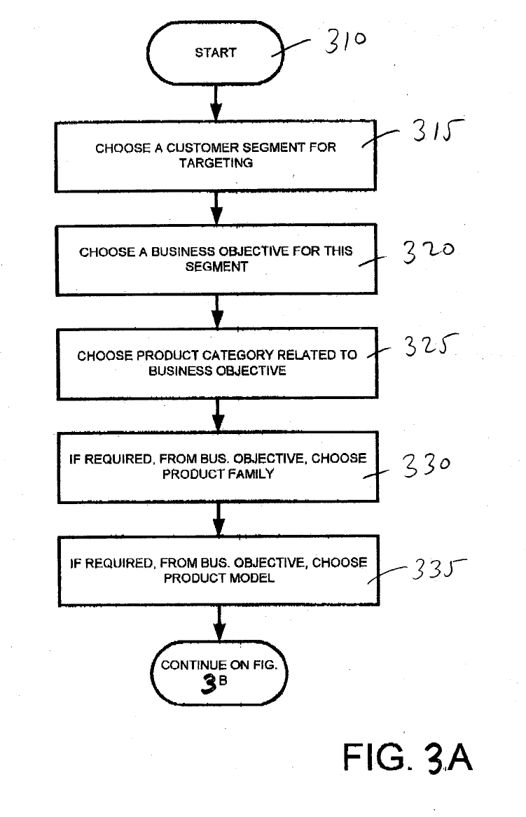

FIGS. 3A and 3B are exemplary flowcharts illustrating the steps for the creation of electronic content and the placement of entries into a content database in accordance with one embodiment of the present invention. Generally speaking, the method to enter the content into the database should be consistently followed so others may later leverage on the stored contents. Furthermore, the temporal sequence shown in FIGS. 3A and 3B is not limiting, and certain steps therein may be performed in a different order if desired. In step 315, a content creator chooses a customer segment that he is targeting. Typically, there is already research that addresses the characteristics and personalities of customers for the kind of products being marketed. For example, referring to the exemplary content database of FIG. 2, the content creator may choose life enrichment, proven productivity, or tech assurance. In the present example, the content creator chooses life enrichment at step 315.

In step 320, the content creator chooses a business objective. Staying with the printer example, the business objective maybe how to inform this particular customer base of a new feature for this printer. In step 325, the content creator may optionally choose a product category relevant to the electronic content at hand. In the present example, the product category is digital imaging. In step 330, the content creator may optionally choose a product family relevant to the electronic content at hand. In this example, the product family is the All-in-One family. In step 335, the content creator may optionally choose a product model. In the current example, model C2132 is chosen.

In step 340, the content creator may choose a modality for the business objective. As shown in FIG. 3B, exemplary modalities include. “drive customer to immediate purchase”, “show product usage scenarios”, etc.

In step 345, from customer research database, choose applicable customer motivation/needs for the given product/family/model. In creating the behavioral change model, the motivation component may be the first component identified, if desired. Generally speaking, the research database is a pre-compiled database from market research separate from the current content database.

In step 350, the content creators/designers develop three content components that tie business objective/modality to a specific customer motivation/need. During this step, the content creators/designer determines implementation techniques for content deployment such as whether to use a single website/page, multiple websites/page, or email, phone, snail mail, etc. or cross-vehicle which can be a combination of the various techniques. Even content deployment within a single website/page can be a composite technique or intra-page technique. The composite technique can provide a single content to accomplish the three components of the behavioral change model (e.g. a video clip). The intra-page technique can provide various links within a single website/page. An inter-page technique can provide multiple websites/pages to deploy the components of the behavioral change model.

In step 355, created content components are placed into content database with descriptive tags associated, along with database links and associations to connected/related other components (e.g., business objective, customer segment, etc.). Preferably, a transform engine can compile the database links and the associations and provide a user interface for searching content. The method ends with step 360.

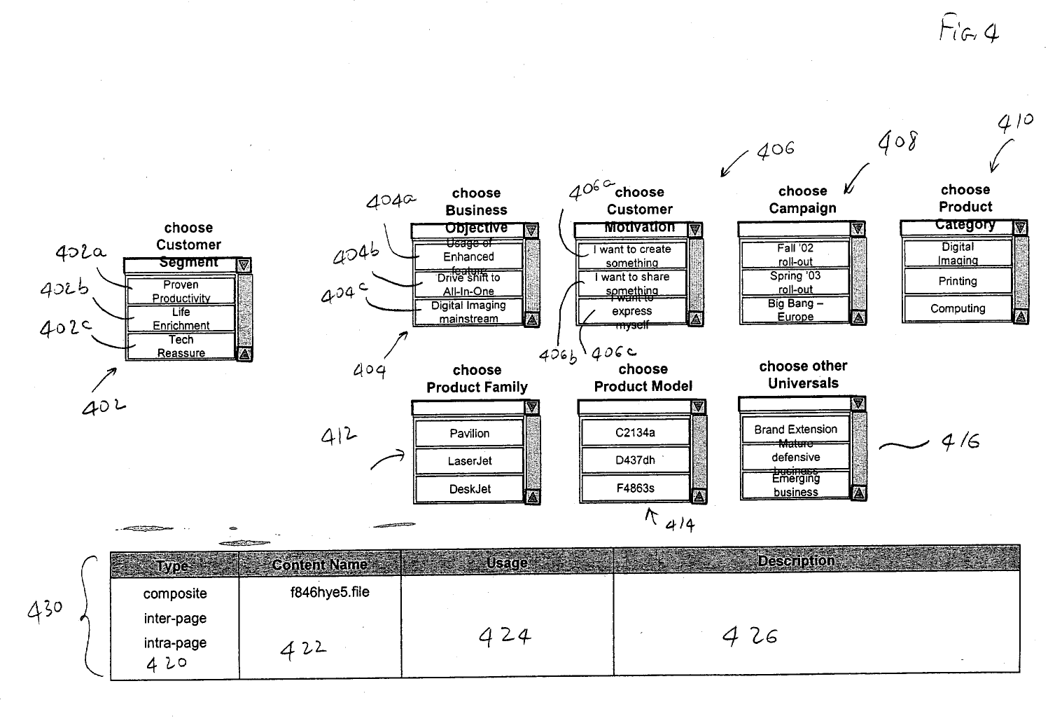

FIG. 4 is an exemplary user interface for extracting a particular electronic content from a content database in accordance to an embodiment of the present invention. The exemplary user interface includes a series of pull-down menus with choices that relate to the values of the tags in the created content database. As in the case with FIG. 3, the temporal sequence shown in FIG. 4 is not limiting, and the various steps therein may be performed in a different order if desired.

For example, a marketeer interested in finding a created content from the content database may be presented with a first pull-down menu “choose Customer Segment” 402. The marketeer can select Proven Productivity 402a, Life Enrichment 402b, or Tech Reassure 402c from the first pull-down menu “choose Customer Segment 402. In the next stage, the marketeer is presented with pull-down menu “choose Business Objective” 404 and three choices “Usage of Enhanced feature” 404a, “Drive shift to All-In-One” 404b, and “Digital Imaging mainstream” 404c. In the following stage, the marketeer is presented with pull-down menu “choose Customer Motivation (need)” 406 and three choices “I want to create something” 406a, “I want to share something” 406b, and “I want to express myself” 406c. Note that after a selection is made in a given pull-down menu, the choices offered in other pull-down menus are automatically adjusted in view of the selection made.

FIG. 4 also shows optional menus 408 (Choose Campaign), 410 (Choose Product Category), 412 (Choose Product Family), 414 (Choose Product Model), and 416 (Choose Other Universals). As menu selections are made, the search results are displayed in window 430. In one embodiment, search results are revised as additional menu selections are made. In another embodiment, search results are shown only after all menu selections are made.

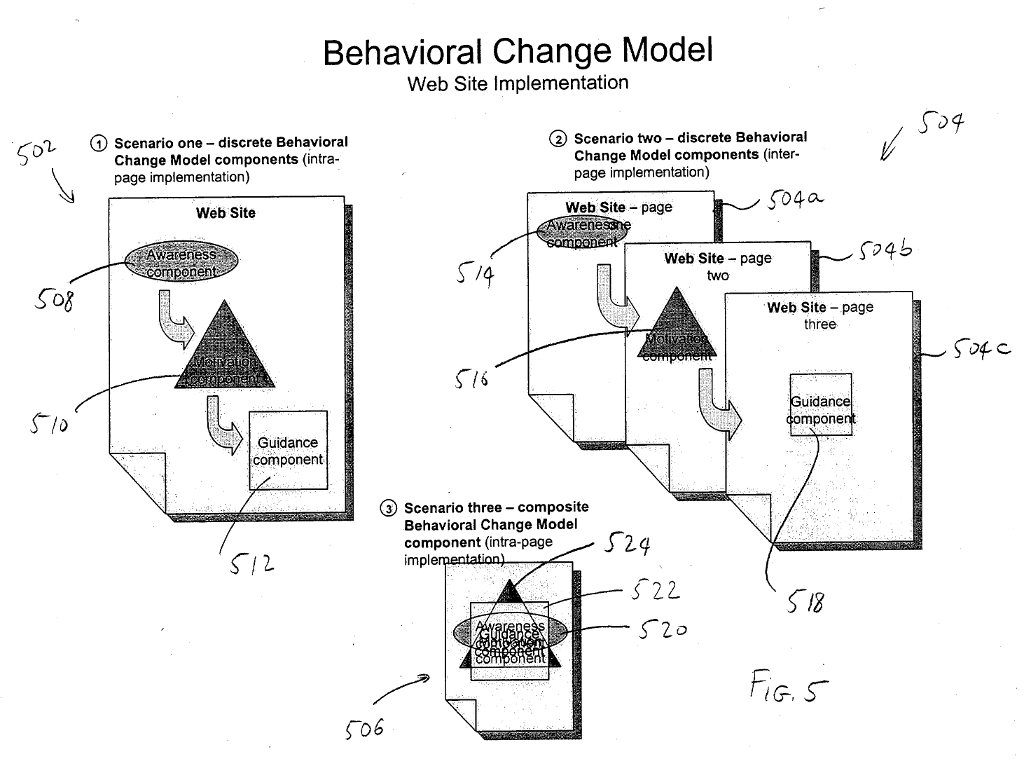

The result table 430 includes a Type label 420, Content Name label 422, Usage label 424, and Description label 426. The Type label 420 indicates whether the content for the three key behavioral change model elements of awareness, motivation, and guidance are disseminated in one composite piece, in an inter-page manner, or in an intra-page manner. These various types will be discussed further in connection with FIG. 5 herein.

The Content Name label 422 indicates the file name of the file that contains the content. In the present example the file is f846hye5.file. The Usage label 424 can include regional information indicating, for example, whether the content is suited in Asia or North America. The Description label 426 can be a quick summary to elaborate on the resultant content file f846hye5.file. The quick summary can include the search criteria that were used to obtain the search result such as the customer objective, business objective, motivation, campaign, etc.

In one embodiment, the content creator may create pieces of content, each of which is specifically directed to a single fundamental component such as awareness, motivation, or awareness. These individual pieces may be cross-linked to a particular customer segment and/or business objective. In such a scenario, the marketeer may search for and receive several pieces of content from the search criteria. One piece may be directed to, for example, the awareness component and another may be directed to, for example, the motivation component, and yet another may be directed to, for example, the guidance component. As another example, one piece may be directed to, for example, the awareness component and the motivation component, and another may be directed to, for example, the guidance component. In this case, the marketeer may assemble together the content components found and employ an appropriate type of delivery mechanism (e.g., composite, inter-page, or intra-page) to deliver the three components of the behavioral change model.

FIG. 5 is exemplary website implementations of the behavioral change model components in accordance to an embodiment of the present invention. Web page 502 represents a website having the behavioral change model components in an intra-page implementation. In the intra-page implementation, awareness component 508, motivation component 510, and guidance component 512 are each discrete and may be linked together within a single website/page. For example, the awareness component 508 can be a video, the motivation component 510 can be graphic, and the guidance component 512 can be textual.

Web page 504 illustrates an inter-page implementation of the behavioral change model elements. A first web page 504a implements an awareness component 514. A second web page 504b implements a motivation component 516, and a third web page 504c implements a guidance component 518. It can be appreciated that the inter-page implementation affords an opportunity to use different vehicles to deliver the information in the electronic content. For example, the awareness component 514 can be an email to the customer, the motivation component 516 can be textual, and the guidance component 518 can be graphic.

Web page 506 is a composite implementation of the behavioral change model components. In this implementation, awareness component 520, motivation component 522, and guidance component 524 are implemented as a single combined element within a single vehicle (page, email, etc.).

In accordance with one embodiment of the present invention, the behavioral change model components afford content providers a way to measure the effectiveness of a particular content. For example, by following the click sequences of customers visiting the website, a content provider can track the movement of the customers through each component element. With reference to the implementation of web page 502, if customers consistently move through the awareness component 508 and continue to the motivation component 510, the content provider can readily determine that the customers' interest is held at least beyond the message that is designed to create customer awareness and/or that the awareness message resonates with the customers.

However, if the customers consistently abandon the web page 502 somewhere within the motivation component 510, the content provider may be alerted that the motivational message may be flawed. By understanding the pathing and monitoring the customer's interaction with the different components of the behavioral change model, the invention allows the content provider to obtain detailed information about the effectiveness of a particular electronic content, the place in the electronic content where customer interest is low, and ultimately to allow the content provider to craft a more effective message to change the customer's behavior.

As can be appreciated from the foregoing, the disclosed behavioral change model enables the creation, development, and deployment of electronic content and in particular of web content to be performed in a deliberate, repeatable, and objective manner. In creating the electronic/web content, recognition is given first to the intrinsic needs and motivations of the customers and the business objective(s). By using the three components of the behavioral change model, and taking into account the target customer segment, the likelihood of success of the electronic/web content created in bridging between the business objective(s) and the business need(s) is substantially increased. The ability to track customer interest with respect to different components of the behavioral change model also allows the electronic/web message to be fine-tuned in an objective and relatively accurate way. Additionally, since created electronic/web content can be readily retrieved using tag value as search indices, the invention allows subsequent users to leverage on the stored content to a much greater extent than was possible in the prior art.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for creating electronic content, comprising:
selecting a customer segment, said customer segment representing a target audience for said electronic content;
selecting a business objective to be accomplished with said customer segment;
selecting a customer need, said customer need pertains to a need by said customer segment;
developing said electronic content, said electronic content being configured to bridge between said business objective and said customer need, said electronic content including 1) an awareness component for raising awareness in said customer segment, 2) a motivation component for relating to said need by said customer segment, and 3) a guidance component for guiding said customer segment toward a behavior.

2. The method of claim 1 further including storing said electronic contents in a content database, said storing including assigning a first tag describing said awareness component, a second tag describing said motivation component, and a third tag describing said guidance component, said storing further including storing said first tag, said second tag, and said third tag in said content database.

3. The method of claim 2 wherein said first tag is cross-linked to said business objective in said content database.

4. The method of claim 2 wherein said first tag is cross-linked to said customer segment in said content database.

5. The method of claim 1 wherein at least two of said awareness component, said motivation component, and said guidance component are presented in a single webpage.

6. The method of claim 5 wherein one of said awareness component, said motivation component, and said guidance component is in a textual form, another one of said awareness component, said motivation component, and said guidance component is visually illustrated.

7. The method of claim 1 wherein at least two of said awareness component, said motivation component, and said guidance component are presented in different webpages.

8. The method of claim 7 wherein one of said awareness component, said motivation component, and said guidance component is in a textual form, another one of said awareness component, said motivation component, and said guidance component is visually illustrated.

9. A method for creating electronic content, comprising:
selecting a customer segment, said customer segment representing a target audience for said electronic content;
selecting a business objective to be accomplished with said customer segment;
selecting a customer need, said customer need pertains to a need by said customer segment;
developing said electronic content, said electronic content being configured to bridge between said business objective and said customer need, said developing said electronic content including obtaining an awareness component, a motivation component, and a guidance component, said awareness component being obtained by searching through a content database for said awareness component that satisfies an awareness component criteria inputted into said content database, said motivation component being obtained by searching through said content database for said motivation component that satisfies a motivation component criteria inputted into said content database, said guidance component being obtained by searching through said content database for said guidance component that satisfies a guidance component criteria inputted into said content database.

10. The method of claim 9 wherein at least two of said awareness component, said motivation component, and said guidance component are presented in a single webpage.

11. The method of claim 10 wherein one of said awareness component, said motivation component, and said guidance component is in a textual form, another one of said awareness component, said motivation component, and said guidance component is visually illustrated.

12. The method of claim 9 wherein at least two of said awareness component, said motivation component, and said guidance component are presented in different webpages.

13. The method of claim 12 wherein one of said awareness component, said motivation component, and said guidance component is in a textual form, another one of said awareness component, said motivation component, and said guidance component is visually illustrated.

14. A method for improving the effectiveness of an electronic content presented to a user via computer-generated outputs, said electronic content having an awareness component for raising awareness in said customer segment, a motivation component for relating to said need by said customer segment, and a guidance component for guiding said customer segment toward a behavior, said method comprising:
a) presenting said awareness component on said computer display screen;
b) thereafter, presenting said motivation component on said computer display screen;
c) thereafter, presenting said guidance component on said computer display screen;
d) ascertaining, during said steps a), b), and c), whether said user terminates reception of said electronic content; and
e) if said user terminates said reception of said electronic content during a given step of steps a), b), and c), flagging said given step to mark said given step as a step during which said user terminates said reception of said electronic content.

15. The method of claim 14 further comprising modifying said given step responsive to said flagging.

16. The method of claim 15 wherein at least two of said awareness component, said motivation component, and said guidance component are presented in a single webpage.

17. The method of claim 16 wherein one of said awareness component, said motivation component, and said guidance component is in a textual form, another one of said awareness component, said motivation component, and said guidance component is visually illustrated.

18. The method of claim 15 wherein at least two of said awareness component, said motivation component, and said guidance component are presented in different webpages.

19. The method of claim 18 wherein one of said awareness component, said motivation component, and said guidance component is in a textual form, another one of said awareness component, said motivation component, and said guidance component is visually illustrated.

20. An arrangement for allowing a user to create electronic content, comprising:
a content database of previously created electronic content components, said electronic content components including data pertaining to customer segments, awareness components, motivation components, and guidance components, each of said awareness components being configured for raising awareness in one of said customer segments, each of said motivation components being configured for relating to a need by said one of said customer segments, each of said guidance components being configured for guiding said one of said customer segments toward a behavior; and
an interface for allowing said user to specify an awareness component criteria, a motivation component criteria, and a guidance component criteria to obtain a set of electronic content components from said content database, each electronic content component in said set of electronic content components satisfying at least one of said awareness component criteria, said motivation component criteria, and said guidance component criteria.

21. The arrangement of claim 20 wherein said interface further allows said user to specify a customer segment criteria, said each electronic content component in said set of electronic content components satisfying said customer segment criteria.

22. The arrangement of claim 20 wherein said database further includes data pertaining to customer needs, said interface further allows said user to specify a customer need criteria, said each electronic content component in said set of electronic content components satisfying said customer need criteria.

23. The arrangement of claim 20 wherein said database further contains data pertaining to business objectives, said interface further allows said user to specify a business objective criteria, said each electronic content component in said set of electronic content components satisfying said business objective criteria.
